(19) United States
(12) Patent Application Publication
(10) Pub. No.: US 2003/0174206 A1
(43) Pub. Date: Sep. 18, 2003

(54) Underwater camera system

(75) Inventor: Peter Moroz, New Hope, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Axial Technologies, Inc.

(21) Appl. No.: 10/387,281

(22) Filed: Mar. 12, 2003

Related U.S. Application Data
(63) Continuation of application No. 09/454,140, filed on Dec. 3, 1999.

(51) Int. Cl. H04N 7/18; H04N 9/47

(52) U.S. Cl. 348/81

(57) ABSTRACT

An underwater observation system has an underwater camera attached to a viewing system. The viewing system has a CRT display disposed within a case. A magnifying antiglare lens is positioned in the case a desired distance from the CRT display to provide a view of images displayed on the CRT. A cable couples the camera to the viewing system. A movable screen is attached to the viewing system to further reduce glare. One or more LEDs are housed in or on a body of the underwater camera. The LEDs may emit red or white light, or a combination of both to provide enhanced visibility of desired objects. The camera body has a removable fin for stabilizing the camera as it moves through water. The cable has marks spaced along the cable to indicate distance from the body of the camera. Alternatively, the camera is provided with a depth measuring sensor. Further sensors include a compass for indicating orientation of the underwater camera and a temperature sensor. A telescoping pole may also be attached to the camera to provide better control of depth and orientation of the camera.

This application is a continuation of U.S. patent application Ser. No. 09/454,140, filed Dec. 3, 1999, which is incorporated herein by reference.

### FIELD OF THE INVENTION

The present invention is related to underwater viewing technologies, and more particularly to an underwater video camera and viewing system.

### BACKGROUND

In the fishing world underwater cameras have been used before to enhance the fishing experience. These cameras have been used for things like watching a lure and seeing how successful a particular jigging action is in attracting fish and checking on the status of live bait attached to a lure. While some systems have been used before, they have had a number of drawbacks.

One problem with prior viewing systems is that they are designed for use by a single viewer. Such viewing systems are set up with a viewing area that is recessed into a viewing case such that the user needs to be right next to a viewing portal to see the monitor. The recessed nature of the viewing area makes it usable by only one person at a time.

Another problem related to viewing is the use of small CRTs. A small CRT creates a small image. This small image makes it hard to view images and reduces the effectiveness of the viewing system. If the image is too small, important details of the underwater environment will not be discernable from those details that are unimportant. This creates a low resolution system that makes it much less useful.

Some prior art viewing systems also utilized LCD types of displays. Such systems did not work well in the sun, which essentially made such displays unviewable without completely shading the display from sunlight and other bright reflections. Further, LCD displays have been more expensive and provide generally lower quality images than CRT displays.

A further problem with current systems is an inability to determine characteristics of the environment around the camera that may enhance fishing opportunities. This includes things like water temperature, depth of the camera underwater, and the direction the camera is facing. It is an additional problem with current systems that there is no easy way of positioning the camera when it is underwater.

Thus, what is needed in the art is an underwater camera system which provides a higher quality display for users. There is a further need for such a system that multiple users can view at the same time. There is yet a further need for an underwater camera system that provides information about the environment around the camera for enhancing fishing opportunities. Finally, there is a need for a convenient method of positioning and repositioning the camera when it is underwater.

### SUMMARY OF THE INVENTION

An underwater observation system has an underwater camera attached to a viewing system. The viewing system has a CRT display disposed within a case. An antiglare lens is positioned in the case a desired distance from the CRT display to provide a view of images displayed on the CRT. A cable couples the camera to the viewing system. In one embodiment, the lens provides magnification of the images displayed on the CRT. The lens may also be coated with an antiglare material. Further, a movable screen may be provided in one embodiment to further reduce glare.

In a further embodiment, one or more LEDs are housed in or on a body of the underwater camera. The LEDs may emit red or white light, or a combination of both to provide enhanced visibility of desired objects. The camera body may have a removable fin for stabilizing the camera as it moves through water.

In yet a further embodiment, the cable has marks spaced along the cable to indicate distance from the body of the camera. Alternatively, the camera is provided with a depth measuring sensor. In still a further embodiment, the camera has a compass for indicating orientation of the underwater camera. The camera may also be equipped with a temperature sensor. The sensors communicate with the viewing system via the cable, and the viewing system provides a visual indication of values of parameters sensed.

The camera may also be equipped with a removable fin to stabilize the camera during motion in the water such as caused by trolling. A telescoping pole may also be attached to the camera to provide better control of depth and orientation of the camera.

### BRIEF DESCRIPTION OF THE DRAWINGS

FIG. 1 is a perspective block representation of an underwater observation system.

FIG. 2 is a perspective block representation of an alternative underwater observation system.

FIG. 3 is perspective view of a further underwater camera.

FIG. 4 is a perspective view of yet another underwater camera.

### DETAILED DESCRIPTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

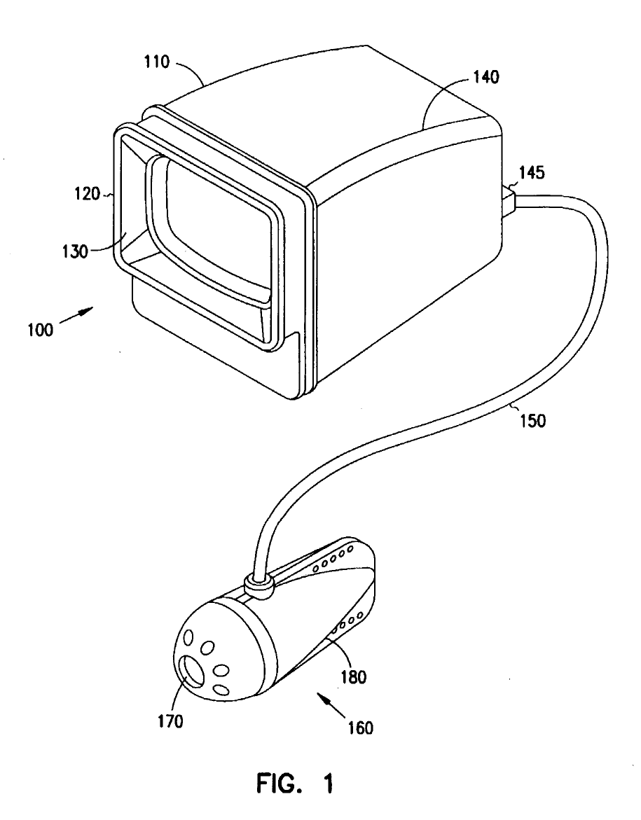

An underwater observation system is shown generally at 100 in FIG. 1. Included in underwater observation system 100 are underwater camera 160, viewing system 110 and connector 145 for connecting to cable 150 coupling viewing system 110 to underwater camera 160. In one embodiment cable 150 is at least 50 feet long. Underwater observation system 100 is powered by a direct connection from viewing system 110 to a standard 12V battery or other type of battery as desired such as is commonly found in fishing boats. In a further embodiment underwater observation system 100 is powered by a connection from viewing system 110 to a standard car or boat cigarette lighter. In one embodiment viewing system 110 is no bigger than 10.4″×7.5″×9.5″ and weighs less than 5.5 pounds. Other sizes and weights may also be used in further embodiments.

In one embodiment, as shown in FIG. 1, underwater camera 160 includes body 180 that houses camera 170. Underwater camera 160 may be less than 5″×2.5″ in size. In one embodiment, camera 170 is capable of producing 525 lines and 270,000 pixels of video output and can process images at 0.1 Lux at approximately 50 cm using a ⅓″ charge couple device (CCD). In one embodiment body 180 is shaped to provide stability for underwater camera 160 when underwater camera 160 is underwater. The underwater camera and associated cables are designed to operate underwater in a manner that is well known in the art. The cable is designed to carry video signals and other data a desired distance, as well as to provide sufficient support for the camera when underwater, including while trolling. It further provides power from the battery powered viewing system 110 to the camera for powering the camera.

Additionally, shown in FIG. 1 is viewing system 110. In one embodiment, viewing system 110 includes case 120, lens 130 and CRT 140 disposed within case 120 and not visible in this view. Lens 130 is coupled to a display end of case 120. Both lens 130 and CRT 140 are housed in case 120. CRT 140 has a display portion which is positioned facing lens 130 within the case such that lens 130 provides magnification of the CRT 140 images at a desired viewing distance from the viewing system 110. Lens 130 provides a magnification of approximately 1.6 when the lens 130 is spaced from the display portion of CRT 140 by approximately seven inches. This magnification provides the ability to utilize a CRT which is smaller and has a better image than previous CRTs, yet viewing system 110 still provides a large image which can be viewed simultaneously by more than one viewer if desired. It also provides a larger image for a single viewer in further embodiments.

Case construction is well known to one of skill in the art and is therefore not detailed here. In one embodiment lens 130 has an anti-glare coating of Ti₂, O₃ and SiO. The anti-glare coating is designed such that it reduces the glare associated with lighting conditions typical in outdoor environments. Additionally, any anti-glare coating known to those of skill in the art may be appropriate. In one embodiment lens 130 has a viewing area with dimensions 5.5″×4″ with a diagonal of 6″. In one embodiment CRT 140 is a 4″ CRT with the ability to display at least 400 TV lines. Other CRTs 140 dimensions may be used, however the smaller size of the CRT is used to reduce the size of viewing system 110 into a more compact and lighter system. In one embodiment lens 130 is a magnifying lens with a magnification factor of approximately 1.6. Other magnification factors may be used in other embodiments, while varying the distance between the lens 130 and CRT 140 to provide a desired viewing distance. When used, magnifying lens 130 enlarges the viewing area to facilitate multiple users viewing the display at the same time. Further, magnifying lens 130 increases the image size so that even if a single viewer is using the system the image is easier to view and use because it is larger.

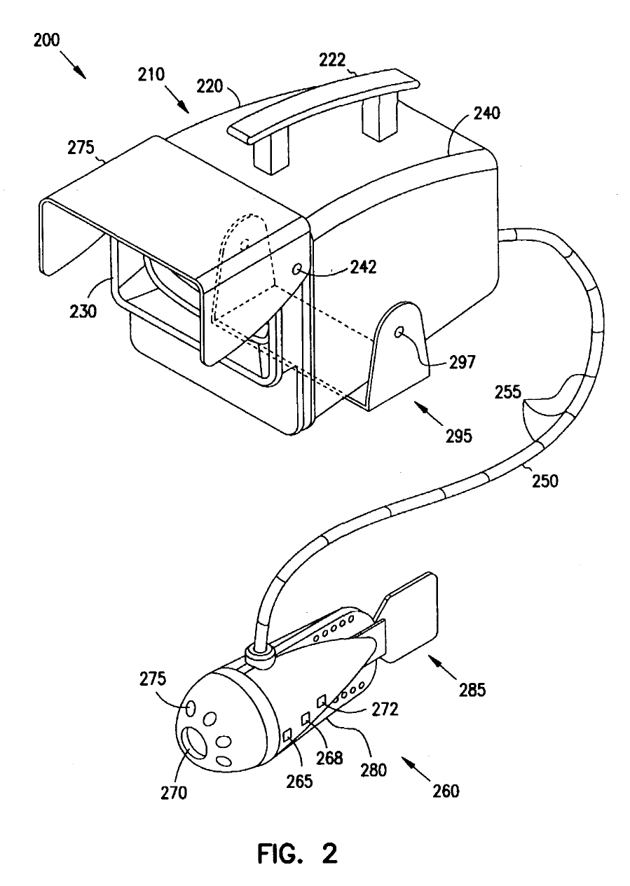

FIG. 2 shows another embodiment of an underwater observation system 200. In one embodiment underwater observation system 200 is no bigger than 10.4″×7.5″×9.5″ and weighs less than 5.5 pounds. Underwater observation system 200 includes viewing system 210, underwater camera 260 and cable 250. Cable 250 couples underwater camera 260 to viewing system 210. In one embodiment cable 250 is 50 feet long. In one embodiment cable 250 has marks 255. Marks 250 are spaced and numbered by one foot intervals in one embodiment to indicate the distance from underwater camera 260 to one the marks 250. A clamp may be used and attached to the boat to clamp the cable in place such that the camera is at a desired depth. Other intervals for marks 250 may also be used. Marks 250 can be used as a depth indicator when underwater camera 260 is underwater.

In one embodiment, as shown in FIG. 2, viewing system 210 includes case 220, lens 230, CRT 240, flip shield 225 and adjustable base stand 290. In one embodiment Lens 230 is coupled to the display end of case 220 opposite that of the viewing surface of CRT 240 also housed in case 220. Case construction is well known to one of skill in the art and is therefore not detailed here. A handle 222 is attached to the top of case 220 for easy handling. In one embodiment lens 230 has an anti-glare coating. For one embodiment the anti-glare coating on lens 230 is made of Ti₂, O₃ and SiO. The anti-glare coating is designed such that it will reduce the glare associated with lighting conditions typical in outdoor environments. Other anti-glare coatings known to those of skill in the art are appropriate. In one embodiment lens 230 has a viewing area with dimensions 5.5″×4″ with a diagonal of 6″. In one embodiment CRT 240 is a 4″ CRT with the ability to display at least 400 TV lines. Flip shield 225 is attached to opposite sides of case 220 by a pair of finger moveable bolts 242, of which one is shown. The flip shield is formed of sheet metal of plastic as desired, and provides a top surface, and side surfaces. The bolts 242 couple the side surfaces to the case 220. The flip shield is adjustable to reduce glare from above and partially on the sides on lens 230 while still allowing more than one person to view the images produced on lens 230. The bolts 242 may be tensioned to allow the flip shield to rotate up and away from the lens 230 to provide an unobstructed view.

In one embodiment an adjustment arm 295 is attached to each side of case 220 at 297 to provide for up and down adjustment about such points of attachment. This allows adjustment of the viewing angle. Arm 295 is essentially a “U” bracket in one embodiment which may be directly attached or secured to suitable structures on a boat or other surface. Securing viewing system 21 0 allows for a more stable system that will ease viewing and prevent viewing system 210 from undesired movement that may damage viewing system 210.

In one embodiment, as shown in FIG. 2, underwater camera 260 includes camera 270, light emitting diode (LED) 275, adjustable fin 285 and body 280. Underwater camera 260 is connected to cable 250 which couples underwater camera 260 to viewing system 210. Camera 270 and LED 275 are housed in body 280 and are coupled to viewing system 210 via cable 250. Fin 285 is a detachable fin that is used to provide additional stability for underwater camera 260. In one embodiment fin 285 is connected to the end of camera opposite the direction camera 270 is facing. LED 275 may be a standard LED. In one embodiment LED 275 emits red light. In another embodiment LED 275 emits light with a wavelength of approximately 660 nm. One example of an appropriate LED is part number LMR53DH as produced by SUN LED, however, other LEDs will also provide adequate illumination. In another embodiment LED 275 emits white light. LED 275 adds light to the viewing area to provide better images even through murky water or when light conditions are otherwise less than desirable.

Further sensors may also be mounted on or integral to camera 260. Such sensors for example include a compass 265, a depth indicator 268 and a thermometer 272 which are housed in or on body 280 of underwater camera 260 and are communicatively coupled to viewing system 210 via cable 250 such as by common two wire configurations which provide both power and data communication. Signals from the sensors may also be multiplexed in the vertical blanking interval if desired, or placed on a separate channel of cable 250. Compass 265 provides information regarding the direction which underwater camera 260 is pointing and relays the directional information to viewing system 210 via cable 250. Depth indicator 268 is used to determine how deep underwater camera 260 is and relays the information to viewing system 210 via cable 250. Further, thermometer 272 is used to determine ambient temperature just outside of underwater camera 260 and relays the temperature information to viewing system 210 via cable 250. In one embodiment, compass 265, depth indicator 268 and thermometer 272 are implemented electronically and embedded in body 280. Visual indications of the sensor data may be selectively superimposed on the CRT image, selectively placed in a window on the CRT image, or even may be provided by a separate display such as an LED or LCD display. The data displayed in on of these formats is selectable by the user of the system via buttons on the case 220, or may be automatically displayed without user interaction.

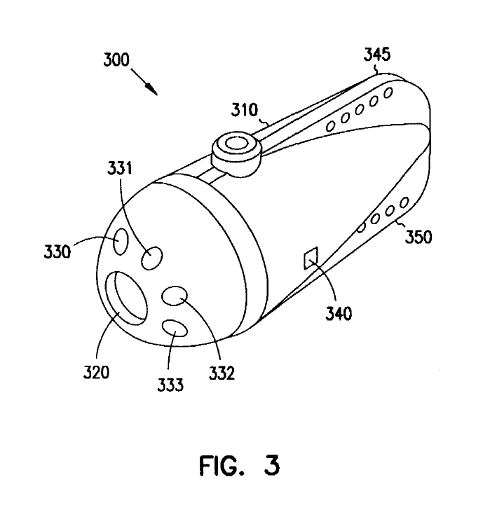

A further variation of an underwater camera is shown generally at 300 in FIG. 3. Underwater camera 300 includes body 310 that houses camera 320, LED 330 and compass 340. In one embodiment underwater camera 300 is less than 5″×2.5″ in size. In one embodiment, camera 300 is capable of producing 525 lines and 270,000 pixels of video output and can process images at 0.1 Lux at approximately 50 cm using a ⅓″ charge couple device (CCD). Body 310 is shaped to provide stability for underwater camera 300 when underwater camera 300 is underwater. LED 330 is a standard LED. In one embodiment LED 330 emits red light. In another embodiment LED 330 emits light with wavelength 660 nm. One example of an appropriate LED is part number LMR53DH as produced by SUN LED. In another embodiment LED 330 emits white light. Any LED 330 incorporated is used to add light to the viewing area and help see fish and other desired objects through dark or murky water. Further LEDs 331, 332 and 333 may also be provided to provide even more viewing light.

Compass 340 is an electronic compass used to determine current orientation of underwater camera 300. Underwater camera 300 is equipped with a pair of opposed tapered posterior fins 345 and 350 beginning near the midpoint of the camera body and stretching to the end of the camera body 310 opposite the lens end. The fins are tapered opposite the direction described, and are thus wider opposite the lens end. A plurality of small holes are formed in the fins.

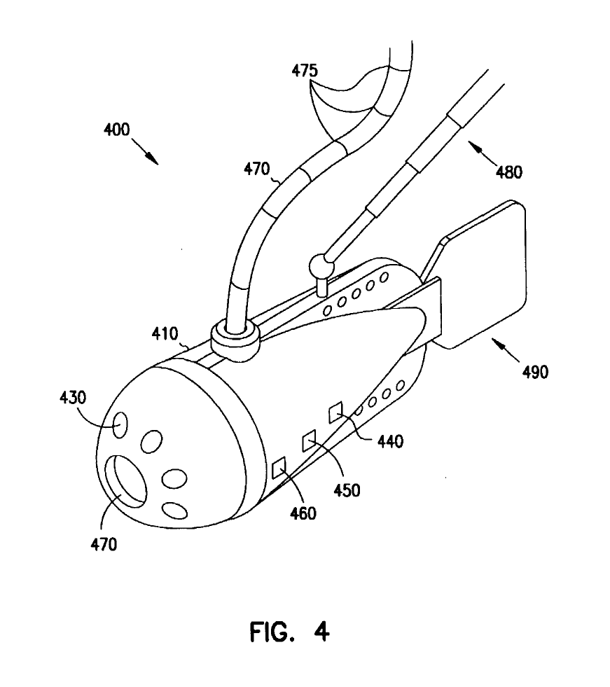

Shown in FIG. 4 is a further embodiment of an underwater camera indicated generally at 400. Underwater camera 400 includes camera 420, light emitting diode (LED) 430, fin 490 and body 410. Underwater camera 400 is connected to cable 470 which can be used to couple underwater camera 400 to a viewing system. Camera 420 and LED 430 are housed in body 410 and may be coupled to a viewing system via cable 470. Fin 490 is an detachable fin that also may be adjusted from side to side to provide desired motion of the camera. It also provides additional stability for underwater camera 400. In one embodiment Fin 490 is connected to the end opposite the direction camera 420 is facing. LED 430 is a standard LED. LED 430 may be one LED or multiple LEDs formed in a ring around camera 420. If multiple LEDs are utilized, they may all emit one form of light as described above, or each or multiple LEDs may emit different selected forms of light. LED 430 adds light to the viewing area such that fish and other desired objects are more visible in dark or murky water.

In one embodiment, as shown in FIG. 4, compass 460, depth indicator 450 and thermometer 440 are housed in body 410 of underwater camera 400 and can be coupled to a viewing system via cable 470. Compass 460 is used to determine which direction underwater camera 400 is pointing and can transmit the directional information to a viewing system via cable 470. Depth indicator 450 is used to determine the depth of underwater camera 400. It transmits the information to a viewing system via cable 470.

Further, thermometer 440 is used to determine ambient temperature and also transmits the temperature information to a viewing system via cable 470. In one embodiment, compass 460, depth indicator 450 and thermometer 440 are implemented electronically and embedded in body 410.

As shown in FIG. 4, underwater camera 400 has a cable 470 attached. Cable 470 may be used to transmit information gathered by underwater camera 400 to a viewing system. In one embodiment, cable 470 has marks 475 along its length. Marks 475 indicate how far a mark 475 is from body 410 of underwater camera 400. Marks 475 may be used to approximate how deep underwater camera 400 is when it is being used underwater.

A pole 480 is detachably attached to body 410 of underwater camera 400. In one embodiment pole 480 is a telescoping pole. Pole 480, when attached, can be used to position underwater camera 400 as the user desires. The pole is attached to underwater camera 400 to provide several degrees of freedom to the camera in one embodiment, while retaining control of at least one axis. It provides that ability to point the camera in a desired direction about a plane parallel to the surface of the water in one embodiment. It may also be attached with no degree of freedom of motion between the pole and the camera to provide absolute control of the pointing of the camera.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. An underwater observation system comprising:
an underwater camera having a body, wherein the body houses:
a camera;
a depth measuring sensor;
a compass, wherein the compass detects the orientation of the underwater camera; and
a temperature sensor, wherein the temperature sensor determines a water temperature;
a viewing system including:
a case; and
a CRT display in the case;
a cable, wherein the cable is used for:
coupling the underwater camera to the viewing system; and
carrying a video signal in a carrier wave from the underwater camera to the viewing system, wherein the video signal includes:
a depth indication sensed by the depth sensor;
a direction indication detected by the compass; and
a temperature indication sensed by the temperature sensor.

2. The underwater observation system of claim 1, wherein the temperature sensor determines the water temperature near the underwater camera.

3. The underwater observation system of claim 1, wherein the compass detects the direction the camera is facing.

4. The underwater observation system of claim 1, wherein the depth sensor determines the depth of the underwater camera.

5. The underwater observation system of claim 1, wherein the underwater camera further includes:
an LED mounted on or in the body.

6. The underwater observation system of claim 5, wherein the, wherein the LED emits visible red light.

7. An underwater observation system comprising:
means for detecting a direction;
means for sensing a temperature; and
means for determining a depth.

8. The underwater observation system of claim 7, further including a camera and an illumination means near the camera for illuminating an area in a directing the camera is facing.

9. An underwater observation system comprising:
a body, wherein the body houses:
a camera, and
a sensor for sensing a parameter;
a viewing system including a video display;
a cable coupled to the camera and the sensor to the viewing system;, the cable carrying a video signal from the camera to the viewing system, wherein the video signal comprises a signal representative of the sensed parameter.

10. The underwater observation system of claim 9, wherein the sensor includes one or more sensors from a group including a depth sensor, a direction sensor, and a temperature sensor.

11. The underwater observation system of claim 9, wherein the signal representative of the sensed parameter is displayable on the CRT.

12. The underwater observation system of claim 9, wherein the sensor is a thermometer for sensing a water temperature near the camera.

13. The underwater observation system of claim 9, wherein the sensor is a compass for sensing the direction the camera is facing.

14. The underwater observation system of claim 9, wherein the sensor is a depth sensor for sensing the depth of the camera under the surface of the water.

15. An underwater observation system comprising:
a camera adapted for underwater use;
a sensor coupled proximate the camera for sensing a parameter;
a viewing system including a video display; and
means for coupling the camera and the sensor to the viewing system and for carrying a video signal and a signal representative of the sensed parameter for display on the viewing system.

16. The underwater observation system of claim 15 wherein the sensor includes one or more sensors from a group including a depth sensor, a direction sensor, and a temperature sensor.

17. The underwater observation system of claim 15 further comprising:
means for illuminating an area in a direction the camera is facing.

18. The underwater observation system of claim 17, wherein the means for illuminating includes an LED that emits light with a wavelength of approximately 660 nm.

19. The underwater observation system of claim 17, wherein the means for illuminating includes means for emitting visible red light.

20. The underwater observation system of claim 17, wherein the video display is a CRT.

21. The underwater observation system of claim 20, wherein the CRT is a black-and-white CRT.

22. The underwater observation system of claim 16, wherein the direction sensor senses a direction in relation to magnetic north.
